(19) United States
(12) Patent Application Publication
(10) Pub. No.: US 2025/0303384 A1
(43) Pub. Date: Oct. 2, 2025

(54) INSULATING LINING, USE OF AN ALUMINA-BASED PART, REACTOR FOR HYDROCARBON REFORMING AND PROCESS FOR HYDROCARBON REFORMING

(71) Applicant: REFRACTORY INTELLECTUAL PROPERTY GMBH & CO. KG, Wien (AT)

(72) Inventors: Dieter PIRKNER, Wiesbaden (DE); Alexander POLLE, Lollar (DE); Alexander KLIMA, Wiesbaden (DE); Wolfgang ENGLMANN, Wiesbaden (DE)

(21) Appl. No.: 18/864,503

(22) PCT Filed: May 2, 2023
(86) PCT No.: PCT/EP2023/061564

§ 371 Date: Nov. 8, 2024

(30) Foreign Application Priority Data
May 9, 2022 (EP) 22172316.6

(51) Int. Cl. B01J 19/02; B01J 19/00; C01B 3/34; C04B 35/10

(52) U.S. Cl. CPC B01J 19/02; B01J 19/0006; C01B 3/34; C04B 35/10; B01J 2219/00162; B01J 2219/0263; C01B 2203/0244; C01B 2203/1241; C04B 2235/3217; C04B 2235/945; C04B 2235/9669

(57) ABSTRACT

The invention refers to an insulating lining, a use of an alumina-based part, a reactor for hydrocarbon reforming and a process for hydrocarbon reforming.

The invention refers to an insulating lining, a use of an alumina-based part, a reactor for hydrocarbon reforming and a process for hydrocarbon reforming.

In hydrocarbon reforming, a reducing high-temperature atmosphere is required.

To carry out hydrocarbon reforming, such a reducing high-temperature atmosphere is provided in a chamber. The chamber is enclosed by a wall. The wall consists of an insulating lining.

The insulating lining must withstand both the reducing atmosphere and the high temperatures prevailing in the chamber during hydrocarbon reforming. Furthermore, the lowest possible heat transfer through the lining is desired. Such a lowest possible heat transfer through the lining is desired, on the one hand, for energy reasons, in particular to keep heat losses through the wall as low as possible for economic and ecological reasons. Furthermore, low heat transfer through the lining is also desired in order to readily maintain the high temperature atmosphere required for hydrocarbon reforming in the chamber. Thus, there is a need to provide an insulating lining for such a wall.

Furthermore, when providing such an insulating lining, it must be taken into account that the lining may regularly only have a maximum thickness. In this respect, firstly, the spatial conditions must be taken into account, which only permit a limited thickness of the lining. Secondly, the strength of the lining material in particular must also be taken into account, which only permits a maximum thickness of the lining associated with a maximum mechanical load.

It is an object of the invention to provide a lining for insulating a reducing high-temperature atmosphere.

In particular, it is an object of the invention to provide a lining for effectively insulating a reducing high-temperature atmosphere.

In particular, it is an object of the invention to provide a lining for insulating a reducing high-temperature atmosphere which allows to be provided with only a small thickness, in particular a reduced thickness compared with insulating linings known from the art.

In particular, it is an object of the invention to provide such a lining for a reducing high-temperature atmosphere in hydrocarbon reforming, preferably a secondary reforming and particularly preferably in an autothermal reforming (ATR).

In order to solve the above problems, there is provided an insulating lining for insulating a reducing high-temperature atmosphere, comprising the following features:
a plurality of layers, wherein said plurality of layers are running parallel and adjacent to each other; wherein
said plurality of layers comprise a first layer and at least one second layer; wherein
said at least one second layer is comprised of high temperature resistant material; wherein
said first layer comprises alumina-based parts and wherein said alumina-based parts comprise at least one hollow alumina-based part, said at least one hollow alumina-based part comprising at least one cavity.

Surprisingly, it has been found according to the invention that the above problems can be solved by providing an insulating lining formed as above. By providing such an insulating lining, an effective insulation of a reducing high-temperature atmosphere can be provided with only a small thickness of the lining. By providing such an insulating lining, energy losses through the lining can be reduced, while at the same time the lining can be provided with a high stability. Furthermore, the lining according to the invention can be provided in such a way that it can withstand a reducing high-temperature atmosphere.

In particular, the present invention is also based on the surprising finding that such an insulating lining that solves the above problems can be provided when the plurality of layers of the insulating lining comprises at least one layer comprising alumina-based parts, and wherein said alumina-based parts comprise one or more hollow alumina-based parts, each of said one or more hollow alumina-based parts comprising at least one cavity. According to the invention, the layer of the plurality of layers of the invention comprising said alumina-based parts is referred to as the “first layer”.

In accordance with the invention, it was surprisingly realized that energy loss can be significantly reduced by an insulating lining to the extent that the lining comprises such hollow alumina-based parts. In this respect, it was also surprising that the insulating lining can nevertheless be provided with a sufficiently high mechanical stability despite the presence of such hollow alumina-based parts. Accordingly, due to this stability of the hollow alumina-based parts, the lining can be provided with a small thickness, in particular, with a thickness smaller than the thickness of linings known from the art. Finally, such hollow alumina-based parts present a high resistance to a reducing high temperature atmosphere.

Generally, the alumina-based parts can be manufactured according to any technology known from the prior art for manufacturing alumina-based parts. In particular, the alumina-based parts may be manufactured according to any prior art technology for the production of refractory alumina-based parts. According to one embodiment, the alumina-based parts may be manufactured on the basis of a mass, i.e. an unshaped refractory material or mixture, and may be manufactured in-situ at the place of their use, i.e., at or in the lining according to the invention. In particular, the alumina-based parts in this case may be cast. According to an alternative embodiment, the alumina-based parts may be provided as prefabricated products, i.e., as bricks or molded parts.

Generally, the alumina-based parts can have any shape, for example, they can be cuboid-shaped, cassette-shaped or have any other shape. Preferably, the alumina-based parts have a shape that allows the parts to be used to build a masonry, preferably a mortarless masonry, as set forth in detail below.

The hollow alumina-based parts of the first layer are characterized by comprising at least one cavity. This cavity may be completely enclosed by the alumina-based material of the hollow alumina-based parts.

Preferably, however, the at least one cavity is not completely enclosed by the alumina-based material of the respective hollow alumina-based part. In particular, this also has the advantages that such an open cavity can, on the one hand, be manufactured more easily and, on the other hand, be filled with an insulating material very easily, as will be described further below. The at least one cavity of the hollow alumina-based part may, for example, be open to only one side, i.e., be formed substantially like a recess or a blind hole. According to an alternative embodiment, however, the at least one cavity may also be open, for example, to multiple sides and to that extent may be formed, for example, like a through hole.

Generally, the cavity can have any volume.

According to the invention, however, it was found that the hollow alumina-based parts exhibit a particularly good insulating effect if the at least one cavity has a minimum volume, in particular a volume of at least 0.01 dm³. Preferably, therefore, it may be provided that the at least one cavity of the at least one hollow alumina-based part has a volume of at least 0.01 dm³. Furthermore, according to the invention, it has been found that the mechanical stability of the at least one hollow alumina-based part may be adversely affected if the at least one cavity has a volume that is too large, in particular a volume exceeding 4.0 dm³. Preferably, therefore, it can be provided that the at least one cavity has a volume of at most 4.0 dm³. A volume of the at least one cavity in the range from about 0.2 to 2.0 dm³ has been found to be particularly advantageous. To this extent, according to one embodiment, it may be provided that the at least one cavity of the at least one hollow alumina-based part has a volume in the range of 0.01 to 4.0 dm³, more preferably in the range of 0.1 to 3.0 dm³, more preferably in the range of 0.2 to 3.0 dm³, and particularly preferably in the range of 0.2 to 2.0 dm³.

According to one embodiment, the at least one hollow alumina-based part has a volume in the range of 1.5 to 6.0 dm³, particularly preferable in the range from 2.0 to 4.5 dm³.

Further, according to the invention, it has been found that the at least one hollow alumina-based part exhibits a particularly good insulating effect therein when the at least one cavity is a minimum volume fraction of the total volume of the at least one hollow alumina-based part. In this respect, a minimum volume of 1% by volume has been found to be particularly advantageous wherein the insulating effect can be improved with increasing the minimum volume to 10% by volume. According to one embodiment, the at least one cavity has therefore a volume of at least 1% by volume, more preferably of at least 5% by volume and most preferably of at least 10% by volume, each relative to the volume of the at least one hollow alumina-based part.

Further, according to the invention, it has been found that the mechanical stability of said at least one hollow alumina-based part may be adversely affected if said at least one cavity occupies a too large proportion of the volume of the hollow alumina-based part, in particular a proportion by volume exceeding 95%, wherein the mechanical stability can be improved with decreasing the maximum volume to 25% by volume. According to one embodiment, it may therefore be provided that the at least one cavity has a volume in the range of 1 to 95% by volume, more preferably in the range of 5 to 95% by volume, even more preferably in the range of 10 to 50% by volume and most preferably in the range of 10 to 25% by volume, each based on the volume of the at least one hollow alumina-based part. The “volume” of the at least one hollow alumina-based part is the volume enclosed by the outer contour of the at least one hollow alumina-based part.

The at least one hollow alumina-based part may comprise one or more of the cavities as disclosed herein. Preferably, each hollow alumina-based part comprises one cavity, as a hollow alumina-based part with only one cavity is particularly easy to manufacture.

The first layer may comprise one or more of the hollow alumina-based parts. Preferably, the first layer comprises a plurality of the hollow alumina-based parts. According to a preferred embodiment, the first layer comprises predominantly the hollow alumina-based parts disclosed herein.

The alumina-based parts of the first layer, i.e., the at least one hollow alumina-based part and the other alumina-based parts of the first layer, are based on alumina, i.e., aluminum oxide (Al₂O₃). “Alumina-based” in the sense of the invention means that alumina is the main component of the alumina-based parts, i.e., the alumina-based parts comprise aluminum oxide in a larger mass fraction than any other component. Such alumina-based parts are highly resistant to a reducing high-temperature atmosphere. Thereby, by increasing the proportion of alumina in the alumina-based parts, their resistance to the reducing high-temperature atmosphere can be improved. According to one embodiment, therefore, the alumina content of said at least one hollow alumina-based part is at least 60% by mass, relative to the mass of the at least one hollow alumina-based part.

According to a further embodiment of this invention, the alumina content of the at least one hollow alumina-based part is at least 90% by mass, more preferably at least 97% by mass, and even more preferably at least 99% by mass, each relative to the mass of the at least one hollow alumina-based part.

Preferably, the amount of impurity oxides in the form of Fe₂O₃, SiO₂ and CaO in the at least one hollow alumina-based part is small. Preferably, the total mass of Fe₂O₃, SiO₂ and CaO in the at least one hollow alumina-based part is less than 10% by mass, more preferably less than 3% by mass and even more preferably less than 1% by mass, relative to the mass of the at least one hollow alumina-based part.

According to one embodiment, the amount of Fe₂O₃ in the at least one hollow alumina-based part is less than 1% by mass, more preferably less than 0.5% by mass, and even more preferably less than 0.3% by mass, each relative to the mass of the at least one hollow alumina-based part.

According to one embodiment, the amount of SiO₂ in the at least one hollow alumina-based part is less than 40% by mass, more preferably less than 20% by mass, even more preferably less than 1% by mass and more preferably less than 0.5% by mass, relative to the mass of the at least one hollow alumina-based part.

According to one embodiment, the amount of CaO in the at least one hollow alumina-based part is less than 10% by mass, and more preferably less than 7% by mass, relative to the mass of the at least one hollow alumina-based part.

The chemical composition of the at least one hollow alumina-based part is determined according to ISO 12677 (fired substance at 1,025° C.).

Generally, the at least one hollow alumina-based part can be made of any alumina-based raw material. Preferably, the at least one hollow alumina-based part is made of fused alumina. Preferably, the at least one hollow alumina-based part is in the form of a sintered part, that is, a part with a ceramic bond. Preferably, the at least one hollow alumina-based part is made of particles of fused alumina sintered together, i.e., the at least one hollow alumina-based part is made of fused alumina having a ceramic bond.

The at least one hollow alumina-based part preferably has a thermal conductivity at 1,200° C. of less than 3.50 W/mK, more preferably less than 3.30 W/mK, determined according to EN 821-2.

Preferably, all of the hollow alumina-based parts exhibit the above features of the at least one hollow alumina-based part.

Preferably, the alumina-based parts of the first layer have the above chemical composition and the above physical properties.

Preferably, the alumina-based parts form a masonry. The first layer in this case represents a masonry formed by the alumina-based parts.

Particularly preferably, the alumina-based parts form a mortarless masonry. Such a mortarless masonry is characterized in particular by the fact that in the masonry adjacent alumina-based parts are in direct contact with one another with their outer surfaces, i.e., in particular are not bonded to one another, for example, by means of a mortar or the like. In order to ensure the stability of such masonry, the secure hold of the alumina-based parts in the masonry can be secured by mechanical means. According to a preferred embodiment, it may be provided that adjacent alumina-based parts in the masonry have corresponding engagement means on their facing surfaces. Such engagement means may, for example, comprise corresponding protrusions and recesses formed on the mutually facing surfaces, by means of which adjacent parts engage with one another to ensure the stability of the masonry. According to a particularly preferred embodiment, it can be provided in this respect, for example, that the alumina-based parts are connected to one another by a tongue-and-groove system. Such a tongue-and-groove system is characterized by the fact that a tongue of an alumina-based part formed on an outer surface engages in a groove formed on the mutually facing surface of an adjacent part. Such an embodiment is shown in detail in the embodiment illustrated in the figures.

A masonry of the first layer preferably comprises predominantly hollow alumina-based parts.

Preferably, the first layer is allowed to be in direct contact with the reducing high-temperature atmosphere. Insofar, the first layer may be the so-called hot face layer, i.e., the layer of a lining facing the hot atmosphere. Therefore, the first layer is arranged in such a way that, when the insulating lining according to the invention is used, it is in direct contact with the reducing high-temperature atmosphere or faces it directly. In other words, the first layer is arranged to be in direct contact with the reducing high temperature atmosphere when the insulating lining according to the invention is used.

According to the invention, it was found that an energy loss by the insulating lining according to the invention can be particularly effectively reduced when the first layer comes into such direct contact with the reducing high-temperature atmosphere during the use of the insulating lining according to the invention. At the same time, the alumina-based parts of the first layer can resist the reducing high-temperature atmosphere particularly effectively.

Preferably, the first layer is an outer or an external layer of the insulating lining according to the invention. This creates the possibility of allowing the first layer to come into direct contact with the reducing high-temperature atmosphere when the insulating lining is used.

According to one embodiment, the at least one cavity is filled with an insulating material. Preferably, the insulating material comprises at least one of the following insulating materials: gas or low-density insulating material.

The gas with which the at least one cavity can be filled is preferably air or process atmosphere, so that the at least one cavity in this case represents a cavity filled with air or process atmosphere, i.e., the reducing atmosphere present in the aggregate in which the lining is used.

The insulating material has a thermal conductivity that is lower than the thermal conductivity of the at least one hollow alumina-based part. Preferably, the insulating material is a low-density insulating material, more preferably at least one of the following low density insulating materials: low density insulating bulk material or ceramic fiber material.

The low-density insulating bulk material may be, for example, expanded perlite.

Particularly preferably, however, the low-density insulating material is a ceramic fiber material. According to the invention, it has been found that the energy loss by the insulating lining according to the invention can be further significantly reduced by the at least one cavity being filled with such a ceramic fiber material.

Particularly preferably, the ceramic fiber material is made of alumina-based ceramic fibers. The term “alumina-based” is defined as set forth above.

In addition to the first layer, the insulating lining according to the invention comprises at least one second layer, wherein the at least one second layer is made of high temperature resistant material.

According to the invention, it has been found that energy loss through the insulating lining according to the invention can be suppressed particularly effectively when the insulating lining comprises at least two second layers. According to a particularly preferred embodiment, it is therefore provided that the at least one second layer comprises at least two second layers. In other words, according to this embodiment, the insulating lining comprises at least three layers, namely the first layer and at least two second layers.

According to a particularly preferred embodiment, the high temperature resistant material is refractory material, particularly preferably refractory ceramic material. Particularly preferably, it is refractory ceramic material that can be permanently exposed to temperatures above 600° C.

Preferably, the high temperature resistant material is based on alumina.

Preferably, the at least one second layer consists of at least 60% by mass, more preferably at least 80% by mass, of Al₂O₃, based on the total mass of the at least one second layer. The proportion of Al₂O₃ is determined according to ISO 12677 (fired substance at 1,025° C.).

The high-temperature resistant material, in particular insofar as this is in the form of a ceramic refractory material, can preferably be at least one of the following materials: refractory bricks, lightweight insulating bricks or refractory castables (i.e., refractory castable compounds).

According to a particularly preferred embodiment, the at least one second layer comprises at least one layer of a refractory castable. According to a particularly preferred embodiment, the at least one second layer comprises at least one layer of an alumina-based refractory castable. Particularly preferably, the alumina-based refractory castable comprises at least 85% by mass Al₂O₃, determined according to ISO 12677 (fired substance at 1,025° C.).

According to the invention, it was found that energy loss can be further suppressed by the insulating lining according to the invention particularly effectively insofar as the lining comprises, in addition to the first layer, a further layer in the form of such an alumina-based casting compound.

According to a particularly preferred embodiment, it is provided that the at least one second layer comprises a layer of a castable, in particular an alumina-based refractory ceramic castable, being an outer layer of the insulating lining.

According to a particularly preferred embodiment, it is provided that the insulating lining according to the invention comprises two opposing outer layers, a first of the outer layers being the first layer and the second of the outer layers being a layer of the at least one second layer formed from a castable, in particular an alumina-based refractory castable, preferably with the features as set forth above. Between these two outer layers, one or more further layers of the at least one second layer may be arranged.

As stated above, in such embodiment the first layer may be arranged particularly preferably in such a way that it comes into direct contact with the reducing high-temperature atmosphere during the use of the insulating lining, while the layer of the castable forms the opposite outer surface, i.e., the cold side, of the insulating lining.

The plurality of the layers of the insulating lining run parallel to each another. Furthermore, the layers run adjacent to each other, with adjacent layers preferably being in direct contact with each other, i.e., contacting or touching each other at their surfaces facing each other.

One object of the invention is the use of a hollow alumina-based part, comprising at least one cavity, in an insulating lining for insulating a reducing high-temperature atmosphere.

As set forth, it has been found in accordance with the invention that the insulating lining according to the invention is particularly advantageous for use in an insulating lining for insulating a reducing high-temperature atmosphere.

According to the invention, it has been found that the insulating lining according to the invention can particularly advantageously be used for isolating a reducing high-temperature atmosphere of a hydrocarbon reforming process, in particular a secondary hydrocarbon reforming process. According to a preferred embodiment, it is therefore provided that the hollow alumina-based part is used in an insulating lining for insulating a reducing high-temperature atmosphere of a hydrocarbon reforming process, particularly preferably a secondary hydrocarbon reforming process.

According to a particularly preferred embodiment, the secondary hydrocarbon reforming process is an autothermal reforming process (ATR), so that a particularly preferred embodiment of the invention is the use of the hollow alumina-based part in an insulating lining for insulating a reducing high-temperature atmosphere in an autothermal reforming process. According to the invention, it has been found that the insulating lining, due to its excellent insulating properties, is excellently suited for an ATR, which, as is well known, no longer requires an external energy supply to maintain the process and must therefore be particularly well insulated.

In particular, the hollow alumina-based part used according to the invention may have the features of the at least one hollow alumina-based part of the insulating lining according to the invention as set forth above.

Further, the insulating lining in which the hollow alumina-based part is used may have the features according to the insulating part lining according to the invention.

A further object of the invention is a reactor for a hydrocarbon reforming process, comprising the following features:
a chamber;
means for providing a reducing high-temperature atmosphere for a hydrocarbon reforming process within said chamber;
a wall enclosing said chamber; wherein
the wall comprises the insulating lining according to the invention.

The hydrocarbon reforming process may in particular be a secondary hydrocarbon reforming process and more preferably an autothermal reforming process. The chamber and means of the reactor according to the invention may be configured, as known in the prior art, to provide a reducing high temperature atmosphere in the chamber for carrying out corresponding processes in the chamber.

Preferably, the reducing atmosphere is an atmosphere based on synthesis gas, i.e., a gas mixture of carbon monoxide (CO) and hydrogen (H₂) or of nitrogen (N₂) and hydrogen (H₂).

A further object of the invention is a hydrocarbon reforming process, comprising the following steps:
providing a reactor according to the invention;
providing a reducing high-temperature atmosphere for a hydrocarbon reforming process within the chamber;
carrying out a hydrocarbon reforming process within the chamber.

As previously stated, the hydrocarbon reforming process may particularly preferably be a secondary hydrocarbon reforming process and particularly preferably be an autothermal reforming process.

These processes may be carried out in the chamber according to the state of the art.

According to a preferred embodiment, the autothermal reforming process is the conversion of methane (CH₄) to carbon monoxide (CO) and hydrogen. Preferably, this conversion takes place by a reaction of methane with at least one of the following: oxygen (O₂), water vapor (H₂O) or carbon dioxide (CO₂).

Further features of the invention will be apparent from the claims, the figures and the accompanying description below.

All features of the invention may be combined, individually or in combination, in any desired manner with each other.

An embodiment of the invention is explained in more detail with reference to the figures and the following accompanying description.

The figures show in

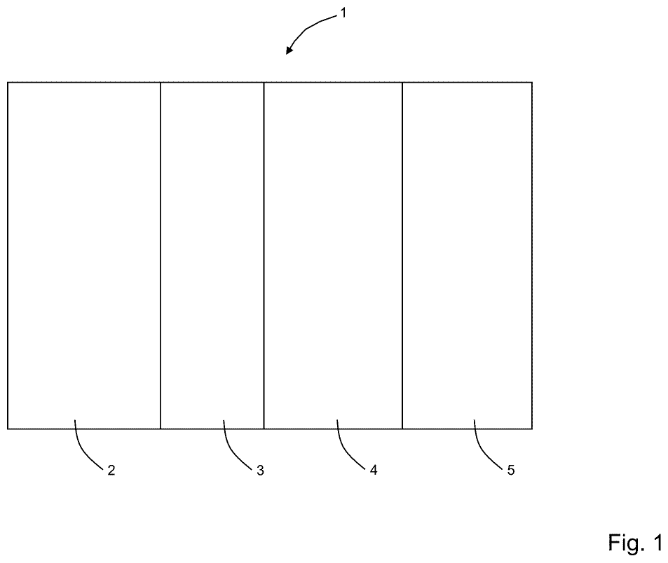

FIG. 1 a sectional view, perpendicular to the course of the layers, of an exemplary embodiment of a lining according to the invention;

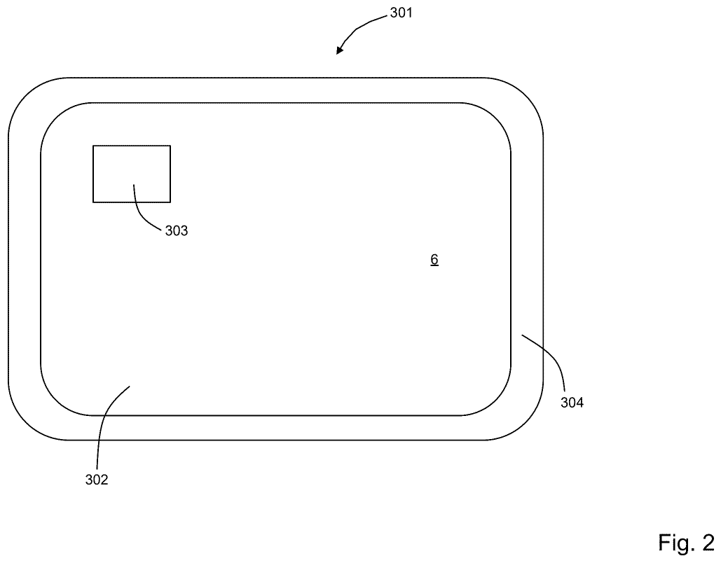

FIG. 2 a sectional view of an exemplary embodiment of a reactor according to the invention, the chamber of which comprises the insulating lining according to FIG. 1;

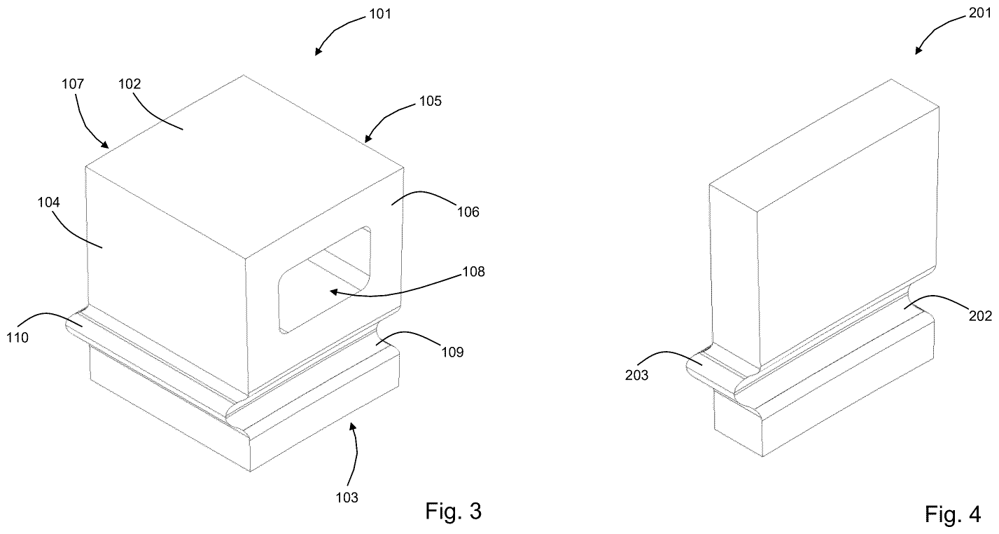

FIG. 3 a perspective view of a hollow alumina-based part of the first layer of the insulating lining according to FIG. 1;

FIG. 4 a perspective view of an alumina-based part of the first layer of the insulating lining according to FIG. 1; and

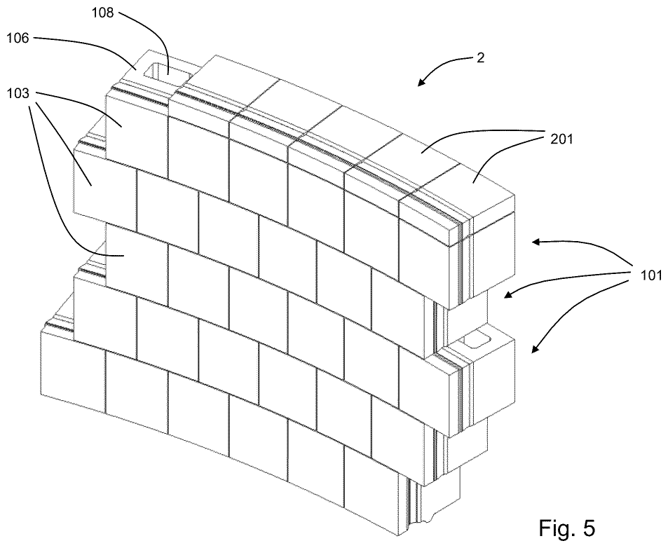

FIG. 5 a perspective view of a part of the first layer of the lining in detail.

FIG. 1 shows a cross-sectional view of a highly schematized embodiment of an insulating lining according to the invention, the section being perpendicular to the course of the layers of the lining. In its entirety, the insulating lining in FIG. 1 is identified by the reference sign 1.

The insulating lining 1 comprises a total of four layers 2, 3, 4, 5, namely a first layer 2 and three second layers 3, 4, 5. The four layers 2, 3, 4, 5 run parallel and adjacent to each other.

The insulating lining 1 comprises two opposite, outer layers, namely the (in FIG. 1 left) outer first layer 2 and the (in FIG. 1 right) outer second layer 5. Between these outer layers 2, 5 are arranged the further two layers 3, 4, the second layer 3 being arranged immediately adjacent to the first layer 2 and the second layer 4 being arranged immediately adjacent to the second layer 5, and the second layers 3, 4 in turn being arranged immediately adjacent to one another.

The insulating lining 1 is arranged such that, when the insulating lining 1 is in use, a reducing high-temperature atmosphere 6 is in direct contact with the first layer 2. Accordingly, the second layer 5 is arranged on the opposite, outer and thus cold side of the insulating lining 1.

The first layer 2 comprises the alumina-based parts 101, 201 shown in FIGS. 3, 4.

The alumina-based parts 101, 201 of the first layer 2 comprise the hollow alumina-based parts 101 as shown in FIG. 3. The alumina-based parts 101, 201 are provided as prefabricated bricks, manufactured by pressing, firing and then provided for the manufacture of the insulating lining 1.

The hollow alumina-based parts 101 have a substantially cuboid outer contour with a back side 102, an opposing front side 103, a top side 106, an opposing bottom side 107, a left side 104, and an opposing right side 105. Each hollow alumina-based part 101 includes a cavity 108. The cavity 108 is substantially channel-shaped and has a substantially rectangular cross-sectional area, perpendicular to the longitudinal axis of the channel or cavity 108. The cavity 108 extends through the hollow alumina-based part 101 between the opposing top and bottom surfaces 106, 107 and is open to each of the top and bottom surfaces 106, 107. The cavity 108 has a volume of about 0.67 dm³, which is about 15% by volume of the volume of the hollow alumina-based part 101.

The hollow alumina-based parts 101 are made of sintered fused magnesia and have the following chemical composition, determined according to ISO 12677 (fired substance at 1,025° C.), relative to the total mass of the hollow alumina-based part 101:
Al₂O₃: 99.3% by mass
Other: 0.7% by mass

Each oxide other than Al₂O₃ is present in a proportion below 0.3% by mass.

The hollow alumina-based parts 101 have an open porosity (according to ISO 5017) of 17.5% by volume and a thermal conductivity (according to EN 821-2) at 1,200° C. of 3.15 W/m K.

In the embodiment shown, the cavity 108 is filled with ceramic fibers (not shown in the figures). The ceramic fibers are alumina-based fibers having a chemical composition with 96% by mass Al₂O₃.

In addition to the hollow alumina-based parts 101, the first layer 2 further comprises the alumina-based parts 201. The alumina-based parts 201 are made of the same material as the hollow alumina-based parts 101 and thus have the same chemical and physical properties as the hollow alumina-based parts 101. The alumina-based parts 201 have a substantially cuboid outer contour.

The hollow alumina-based parts 101 have grooves 109 and tongues 110 on their surfaces. The alumina-based parts 201 also have grooves 202 and tongues 203 on their surfaces.

In FIGS. 3 and 4, the hollow alumina-based parts 101 and the alumina-based parts 201 are not shown in their use position, i.e., in the position used in the insulating lining 1. The use-position is shown in FIG. 5.

FIG. 5 shows in detail a part of the first layer 2 of the insulating lining 1. As shown in FIG. 5, in the first layer 2, the alumina-based parts 201 and the hollow alumina-based parts 101 form a jointless masonry structure. The grooves 109 and tongues 110 of the hollow alumina-based parts 101 and the grooves 202 and tongues 203 of the alumina-based parts 201 of adjacent alumina-based parts 101, 201 interlock in such a way that a mechanically stable, jointless masonry is provided. In the embodiment shown, the hollow alumina-based parts 101 are arranged in five rows one above the other, wherein within each of the five rows hollow alumina-based parts 101 are arranged one beside the other. The five rows are arranged one above the other, each offset by half the width of the front side 103 of the hollow alumina-based parts 101, giving the masonry additional stability. On top row of the five rows of the hollow alumina-based parts 101, alumina-based parts 201 are arranged in such a way that the cavities 108 are closed on the top surface 106 by the alumina-based parts 201.

In the first layer 2, the hollow alumina-based parts 101 are each arranged such that the front side 103 faces the reducing high-temperature atmosphere 6 and the top side 106 faces upward.

The second layer 5 of the insulating lining 1, which is opposite the first layer 2, consists of a refractory ceramic castable of hydraulically bonded fireclay, lightweight raw materials of the following chemical composition (determined in accordance with ISO 12677 on substance fired at 1,025° C.):
Al₂O₃: 65.0% by mass
SiO₂: 24.7% by mass
CaO: 8.2% by mass
Other: 2.1% by mass

Each oxide other than Al₂O₃, SiO₂ and CaO is present in a proportion below 0.8% by mass.

Layer 4, adjacent to the second layer 5, also consists of a refractory ceramic castable of hollowsphere fused alumina of the following chemical composition (determined according to ISO 12677 on substance fired at 1,025° C.):
Al₂O₃: 92.0% by mass
CaO: 6.6% by mass
Other: 1.4% by mass

Each oxide other than Al₂O₃ and CaO is present in a proportion below 0.6% by mass.

The thermal conductivity according to Dr. Klasse (Klasse, F.; Heinz, A.; Hein, J.: Vergleichsverfahren zur Ermittlung der Wärmeleitfähigkeit keramischer Werkstoffe. Ber. DKG 34 (1957), S. 183-189) at 1,200° C. is 0.89 W/mK.

Layer 3, located between layer 4 and the first layer 2, consists of ceramic-bonded bricks of hollowsphere fused alumina. The bricks of layer 3 have the following chemical composition according to ISO 12677 (fired substance at 1,025° C.):
Al₂O₃: 99.0% by mass
Other: 1.0% by mass

Each oxide other than Al₂O₃ is present in a proportion below 0.7% by mass.

The thermal conductivity at 1,200° C. according to ASTM C182 is 1.17 W/mK.

The insulating layer only has a small thickness, with a thickness of the first layer 2 of 175 mm, the thickness of layer 3 of 116 mm, the thickness of layer 4 of 136 mm, and the thickness of layer 5 of 150 mm.

The insulating lining 1 shown in the embodiment is used to insulate a reducing high-temperature atmosphere of an autothermal reforming process (ATR). A reactor for carrying out such an autothermal reforming process is shown in highly schematized form in FIG. 2.

The reactor 301 according to FIG. 2 comprises a chamber 302 and means 303 by which a reducing high temperature atmosphere 6 can be provided for carrying out an autothermal reforming process in the chamber 302. The chamber 302 is enclosed by a wall 304. The wall 304 comprises an insulating lining 1 according to the embodiment shown in FIGS. 1, 3 and 4. The insulating lining 1 is arranged such that the first layer 2 faces the chamber 302 or a reducing high temperature atmosphere 6 formed in the chamber 302, such that the first layer 2 directly contacts the reducing high temperature atmosphere 6 during operation of the reactor 301.

According to the embodiment, a reducing high temperature atmosphere 6 is provided in the chamber 302 by means 303. The temperature of this atmosphere is about 1,250° C. The atmosphere is a reducing atmosphere based on synthesis gas, namely, a mixture of gases based on carbon monoxide (CO) and hydrogen (H₂).

This reducing high temperature atmosphere 6 could be excellently isolated by the insulating lining 1. The temperature at the side of the first layer 2 facing layer 3 was only 943° C. The temperature at the outer surface of the outer layer 5 was only 148° C. At the same time, the insulating lining 1 proved to be mechanically stable, with the first layer 2 proving to withstand the reducing high-temperature atmosphere 6.

1. An insulating lining (1) for insulating a reducing high-temperature atmosphere (6), comprising the following features:
1.1 a plurality of layers (2, 3, 4, 5), wherein said plurality of layers (2, 3, 4, 5) are
1.1.1 running parallel and
1.1.2 adjacent to each other; wherein
1.2 said plurality of layers (2, 3, 4, 5) comprise a first layer (2) and at least one second layer (3, 4, 5); wherein
1.3 said at least one second layer (3, 4, 5)
1.3.1 is comprised of high temperature resistant material and
1.3.2 comprises at least two layers; wherein
1.4 said first layer (2)
1.4.1 comprises alumina-based parts (101, 201), wherein
1.4.2 said alumina-based parts (101, 201) comprise at least one hollow alumina-based part (101), said at least one hollow alumina-based part (101) comprising at least one cavity (108), wherein
1.4.3 said alumina-based parts (101, 201) form a masonry and wherein
1.4.4 said alumina-based parts (101) provide a tongue-and-groove system.

2. The insulating lining (1) according to claim 1, wherein the alumina content of said at least one hollow alumina-based part (101) is at least 60% by mass, relative to the mass of said at least one hollow alumina-based part (101).

3. The insulating lining (1) according to claim 1, wherein said at least one cavity (108) has a volume of at least 5% by volume, relative to the volume of said at least one hollow alumina-based part (101).

4. The insulating lining (1) according to claim 1, wherein said high temperature resistant material is refractory material.

5. The insulating lining (1) according to claim 1, wherein said high temperature resistant material is based on alumina.

6. Use of a hollow alumina-based part (101), comprising at least one cavity (108), in an insulating lining (1) according to claim 1 for insulating a reducing high-temperature atmosphere (6).

7. The use according to claim 6, wherein said reducing high-temperature atmosphere (6) is a reducing high-temperature atmosphere of a hydrocarbon reforming process, preferably a secondary hydrocarbon reforming process.

8. A reactor (301) for a hydrocarbon reforming process, comprising the following features:
8.1 a chamber (302);
8.2 means (303) for providing a reducing high-temperature atmosphere (6) for a hydrocarbon reforming process within said chamber (302);
8.3 a wall (304) enclosing said chamber (302); wherein
8.4 said wall (304) comprises said insulating lining (1) according to claim 1.

9. A hydrocarbon reforming process, comprising the following steps:
A. providing a reactor (301) according to claim 8;
B. providing a reducing high-temperature atmosphere (6) for a hydrocarbon reforming process within said chamber (302);
C. carrying out a hydrocarbon reforming process within said chamber (302).
